(19) United States
(12) Patent Application Publication
(10) Pub. No.: US 2016/0215897 A1
(43) Pub. Date: Jul. 28, 2016

(54) APPARATUSES AND SYSTEMS FOR PREVENTING AND CONTROLLING ACCIDENTAL GAS DISCHARGE

(71) Applicant: Varywealth Limited, Hong Kong (HK)

(72) Inventor: Chi Wai Chow, Hong Kong (HK)

(21) Appl. No.: 14/603,343

(22) Filed: Jan. 22, 2015

(51) Int. Cl. F16K 27/12

(52) U.S. Cl. CPC F16K 27/12

(57) ABSTRACT

According to embodiments of the invention, systems, apparatuses, methods and devices are provided for controlling accidental discharge of pressurized gases from entry point of a pressurized tubular member containing the pressured gases. In one embodiment, an apparatus is provided that includes a tubular member and a tubular port body. The tubular member holds the pressurized gases in an at least a partial gas phase and the tubular port body is threaded to an upper part of the tubular member in a sealed position. The apparatus may also have a dual channel valve top assembly and a discharge route. The dual channel valve top assembly can be disposed within the tubular port body. A first port is utilized to fill the tubular member with a pressurized gas, and a second port in gas communication with an entry point of the tubular member to discharge the pressurized gas.

### FIELD OF THE INVENTION

The present invention relates to gas containers and more particularly to preventing and controlling accidental discharge of pressurized gases.

### BACKGROUND OF THE INVENTION

The production of many industrial processes and implementation require the use of gases. These gases are usually stored in cylinders of which the gases are compressed. Given the pressurized nature of the gases, safety requirements must be properly managed and followed. There are many well-known safety guidelines concerning pressurized gas containers. For example, containers containing pressured gases should not be subjected to rough handling or abuse. Such improper use can seriously weaken or even damage the containers. Also, when transporting a container from one place to another, cylinders should never be rolled or dragged. The cover cap should be screwed on hand tight and remain on until the cylinder is in place and ready for use before the valve of the containers can be properly be disengaged. Further, when moving large containers, the containers should be tied to a properly designed wheeled vehicle to ensure stability of the gas containers.

Until recently, valve control of gas containers includes using actuators driven by electric motors. An electric valve actuator can be used to remotely control the gas containers without the need for manually turning the valves. Although all of these actuators run on electricity, the designs can vary greatly, and they come in a variety of sizes to fit different valve applications. Advantageously, using electric valve actuators can reduce human labor and enhance efficiency by applying turning force accurately to engage or disengage the valves. However, precautions of installing and using electric valve actuators should be safeguarded. If the valve device causes leaking gas, explosions can occur that can lead to disastrous consequences. Therefore, it is an objective of the disclosed technology to provide a safe valve system avoiding such a disaster.

In view of the foregoing, there is a need for apparatuses, systems and/or methods for preventing and controlling accidental discharge of fluids from valves, vessels, conduits, and other fluid-containing systems.

### SUMMARY OF THE INVENTION

According to embodiments of the invention, systems, apparatuses, methods and devices are provided for controlling accidental discharge of pressurized gases from entry point of a pressurized tubular member containing the pressured gases. In one embodiment, an apparatus is provided that includes a tubular member and a tubular port body. The tubular member holds the pressurized gases in an at least a partial gas phase and the tubular port body is threaded to an upper part of the tubular member in a sealed position.

Further in the embodiment, the embodied apparatus also includes a dual channel valve top assembly and a discharge route. The dual channel valve top assembly can be disposed within the tubular port body. A first port is utilized to fill the tubular member with a pressurized gas, and a second port in gas communication with an entry point of the tubular member to discharge the pressurized gas.

Additionally, the included discharge route is defined in part by the second port body and the entry point, and further including a restricted discharge route and a flow channel disposed upward of the second port body, but wherein the discharge route excludes a restrictive element selected from a group of pressure directors, control valves and controlled flow opening. The restricted discharge route may be used to limit flowing rate of the gas discharged from the tubular member when the entry point of the tubular member is exposed to a condition where an unexpected incident occurs.

In a further embodiment, the upper part or portion of the tubular member may be driven by machines or other powering machines. In one embodiment, such a machine or powering machine includes an electric motor. Still further, the electric motor can be movably connected to the dual channel valve top assembly through a driving train connecting to the electric motor such as a shaft.

In a different embodiment, the tubular port body may be connected to the entry point through a spring mechanism. Further, a second spring like mechanism can be employed to connect to the entry point through the shaft of the electric motor.

To provide physical safety, another embodiment includes adding a protective cover to the embodied apparatus to protect the electric motor. Further, to provide added flexibility, the protective cover may be adapted to be rotatably coupled to the electric motor. And yet, a side of the protective cover may also include an adapter for receiving electricity, whereas the protective cover includes an insulating member.

Additionally, in the embodiment, the apparatus may further include an indicator when the apparatus is operating. Moreover, a metal filter upstream of the restrictor discharge route is provided, so that the flow channel may be disposed downstream of the restrictor discharge route and in communication with the second port.

In a further embodiment of the disclosed apparatus, a discharge route may be defined in part by the second port body and the entry point, and further includes an excess discharge route and a flow channel disposed upward of the second port body. In a different embodiment, the gas flow discharge route may exclude a restrictive element selected from a group of pressure directors, control valves and controlled flow openings. The excess discharge route may isolate flow from the tubular member in the event that an incident arises due to pre-set flow rate is exceeded than a threshold value.

### BRIEF DESCRIPTION OF THE DRAWINGS

FIG. 1 shows an apparatus for using an electric motor according to an embodiment of the present invention.

FIG. 2 shows a schematic diagram illustrating an application of the apparatus involving a connection to an external deposition tool.

FIG. 3 shows a typical cylindrical tank valve assembly onto which methods and apparatuses of the prior art may be used.

FIG. 4 is a high-level block diagram of a microprocessor device that may be used to carry out the disclosed technology.

### DETAILED DESCRIPTION

Referring now to the figures, systems, apparatuses, methods and devices are provided for controlling accidental discharge of pressurized gases from an entry point of a pressurized tubular member containing the pressured gases. In one embodiment, an apparatus is provided that includes a tubular member and a tubular port body. The tubular member holds the pressurized gases in an at least a partial gas phase and the tubular port body is threaded to an upper part of the tubular member in a sealed position.

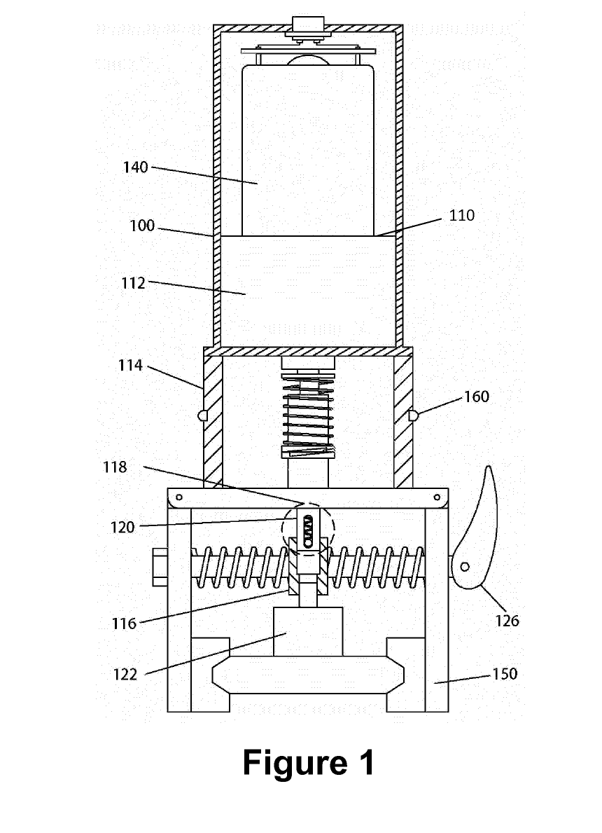

Referring now to FIG. 1, an apparatus is shown for using an electric motor according to an embodiment of the present invention. With reference to the figure, an apparatus 100 for controlling the discharge of pressurized gases, in accordance with an illustrative embodiment of the invention is described. The apparatus 100 includes a gas storage and dispensing tubular member 110, defining and referring to an interior space 112, as shown.

At the neck of the container, a container port body 114 including a dual-channel valve top assembly 116 is readily engaged with the interior threaded opening of collar 118. The dual-channel valve top assembly 116 includes a gas flow discharge passage 120 joined in gas flow communication with a central working volume opening in the valve top assembly. The central working volume opening is in turn in communication to entry point port 122, which may be externally threaded or otherwise constructed for attachment of a connector and associated pipes, tubes, etc. thereto.

Oriented in the central working space opening is a valve element 124 that is joined to a hand tool 126 in the embodiment shown, but may alternatively be joined to an machine-controlled valve actuator or other controller, such as electronic actuating devices.

The valve top assembly 116 also features in the valve block a fill passage communicating with fill valve and the interior space 112 of the funnel. The funnel may thereby be charged with pressurized gas, following which the fill port is closed and capped. These types of dual-channel valves are commercially widely available.

The central gas flow discharge passage 120 in the valve top assembly 114 is joined at its lower end to a restrictive flow route including a filtering device located at the inside of the restrictive flow route. The inlet is disposed in the gas space and in the case of liquefied compressed gases, above the liquid gas maintained in funnel 110. The use of the restrictive flow route increases safety in the event the valve top assembly 114 is taken off, or otherwise the entry point of the high tubular member pressure is opened to a condition where unexpected incident occurs. In which case, an insulating member 160, such as an electrical insulator may be used to make it very difficult to conduct an electric current under the influence of an electric field caused by electric leakage.

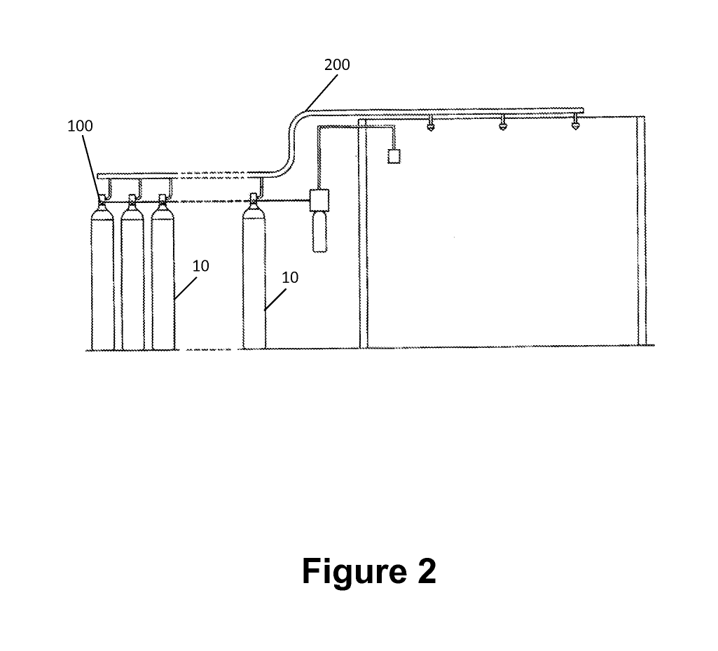

FIG. 2 shows a schematic diagram illustrating an application of the apparatus involving a connection to an external deposition tool. In particular, the preferred assembly of the restrictive flow route is uniformly sized tubes which offer flexibility and reliability. The tubes of the restrictive flow route limits the flow rate of the gas discharge from the tubular member to not more than its maximum capacity. However, neither the restrictive flow route nor the apparatus taken as a whole includes a restrictive element selected from the group of pressure directors, check valves or restrictive flow opening. Referring to the Figure, multiple compressed gas/fluid tanks 10 are arranged along a single conduit 200. The each tank 10 is attached to the conduit 200 using the apparatus 100.

Specifically, and with reference to the figure, a tube defines at least two passages, wherein the internal diameter of the tubes will be on the order of about tens of micrometers or less. For two tubular passages, this diameter limits the rate of release of a tubular member having a saturating pressure that can force through the tube to less than the maximum capacity. Typical flow rates required by end-users are found in the low ranges. At a normal rate, it can take long hours for the container to empty. Therefore, the diameter of the multiple tubes will ordinarily be less than a hundred micrometers.

The length as well as the diameter of the tube may be adjusted to provide a maximum desired flow rate through the restriction. In the case of fast delivery at the previously mentioned rates, the tube is typically less than ten centimeters long. For that length, it would require two tubes in parallel with a diameter of less than a hundred micrometers to provide about the same flow capacity. The multiple tube passages in the tubular member of this invention may be as small as a few microns. However, the size of the tube passages will usually be set to use not more than eight and not less than two tube passages to provide numerous passages while still allowing gas release at reasonable flow rates.

A useful feature of this invention is the provision of the essentially round outer cross section of the tube with the relatively uniform internal tube passages. The internal open flow area through the tube will be defined almost entirely by the regular tubes. Those include cross sections in the form of the same regularly recurring shape. The regular tubes preferably have a round cross section. The roundness of the individual tube passages may be defined by the variation in diameter, taken along any two lines of direction across the substantially circular cross section of each tube passage. The uniformity of the different uniform tube passages may be defined by the variation in average diameter between tubes not exceeding a certain threshold value. Any remaining flow area through the tube is typically in the form of irregular tube sized passages having individual cross sectional areas that are less than the individual cross sectional areas of the regular tube passages. Typically, the irregular tubes will have an average cross sectional area that equals or less of the average flow area of the regular tubes. The relatively small diameter of the irregular tubes minimizes the detrimental effect that the presence of the irregular tubes may have on the regulation of the flow rate through the restrictor.

The preferred structure of the restrictive flow route is a uniform multi-tube assembly, where the tube may be wound for extra strength, or otherwise configured in substantially straight parallel passages. The tubes may take the form of elongated shafts or rods, and the outer wall of the conduit, as well as the tubes themselves may be manufactured from any material that is suitably made into such a structure. Thus, the resulting tube structure has an operating temperature that is limited by the stability or transition temperature of the material defining the tubes. Tubes of this size may be made from various glass materials. Drawing techniques used for forming glass fibers and tubes lend themselves most readily to the production of the tube structure of this invention. Suitable glass materials include lead glasses and other forms of high purity materials used in the industry.

The thickness of the glass wall relative to the tube diameter may be made quite large to overcome the fragility of glass. Proper containment can further overcome any fragility of glass. As shown by the cross-sectional view in the figure, in this embodiment, tube preferably defines a hexagon arrangement of six tube passages that surround a central tube passage and wherein all of the tubes have the same relative diameter.

The tube may be surrounded by an outer sleeve to provide additional support and structural integrity. Such sleeves may be constructed of metallic materials. An optional metal tube, typically constructed from stainless steel, may protectively surround the glass tube. Metal tube adds further rigidity and durability when optionally shrunk around structure and provides a reinforced unit. With the optional reinforcement of metal tube, fracture of the glass tube would again leave the function of the restricted discharge route through tube arrangement substantially unchanged. An especially beneficial arrangement may shrink a metallic sleeve around a glass multi-tube assembly to compress the tube into the sleeve. An arrangement such as this may provide the needed structural support for imposing the necessary ultra-high pressures that are required to push many gases through tubes that approach micrometers in diameter.

The tube arrangement may be manufactured using a forming method that readily provides the assembly structure of this invention and in particular a uniform multi-tube assembly. The method forms the multi-tube tube or conduit with a substantially circular perimeter that surrounds a plurality of regular tube passages defined by internal walls within an outer wall. The method starts with inserting a plurality of smaller conduits into a surrounding tube to form a tube and conduit assembly. The conduits may be formed by drawing down the tube stock to the desired conduit size. The number of inserted conduits will correspond with the number of regular tubes obtained by the forming method. Common openings of the conduits are sealed about one end of the tube and conduit assembly to form a drawing stock having a closed end about which all conduits are sealed from gas flow and an opposite open end about which all conduits are open for gas flow. The drawing stock is then heated to a softening temperature in a suitable drawing apparatus.

Simultaneously drawing the heated drawing stock while restricting gas flow from the open conduit ends of the drawing stock reduces the interiors of the conduits to tube size while preventing collapsing closure of the conduit interiors. A multi-tube tube that has a number of tube passages substantially equal to the number of conduits may be recovered from the stretched and cooled drawing stock. In many cases the reduction of the diameter of the conduits during the drawing of the heated drawing stock provides sufficient reduction in the diameter at their open ends to suitably restrict gas flow out of the interiors of the conduits to a rate that maintains the desired final diameter of the tube passages formed from the conduits 150.

In another embodiment of the invention, upward of the restrictive flow route, a filter unit having a tubular fitting portion that is threaded or otherwise engaged to the restrictive flow route, for engagement, to remove leaking particulates. The filter can be any suitable membrane, screen or sintered metal filter, known in the art as a frit filter, which would be resistant to the high pressures within the tubular member.

Further, the tubular member is in gas communication with a semiconductor tool, such as a vapor deposition tool. Disposed on the line between the tubular member and the tool is a mass flow controller, which controls the flow rate of gas delivered to the tool.

In an alternative embodiment, tube arrangement can be used in combination with or replaced by an excess flow valve assembly upward of the central gas flow discharge passage, or alternatively upward of the valve. The excess flow valve assembly is set to prevent the flow of gas from funnel once a preset flow rate is exceeded. The preset flow rate is the maximum flow rate of the gas passing through the device. For example, the excess flow valve may be set to allow delivery of gas flows from zero up to a few thousands but if for any reason the flow rate through the device were to exceed to a certain extent (such as a component failure or leak downstream of the device) the excess flow valve would close and prevent any further release of gas. In the event of a component failure or leak this device would prevent further escape of gas thereby retaining the remaining gas inside the tubular member or storage vessel. This feature alone or in combination with the tube flow restrictor greatly enhances the safety, environmental and health features of the tubular member package. Therefore, upon actuating tool, and opening valve, or otherwise sheering off valve head, the excess flow valve assembly limits the gas flow rate to approximately zero unit. Additionally, another excess flow valve could be attached or in communication with the flow route and upward of valve where in the unlikely event of a complete valve shear the flow of gas through port would also be blocked thereby preventing the escape of gas from the vessel through different units. The operation of the excess flow valve is a mechanical device that senses a differential pressure across the device and stops flow through the device when a preset differential or maximum flow rate is exceeded. Devices of this type are widely commercially available, particular using driving force with electric motors 140.

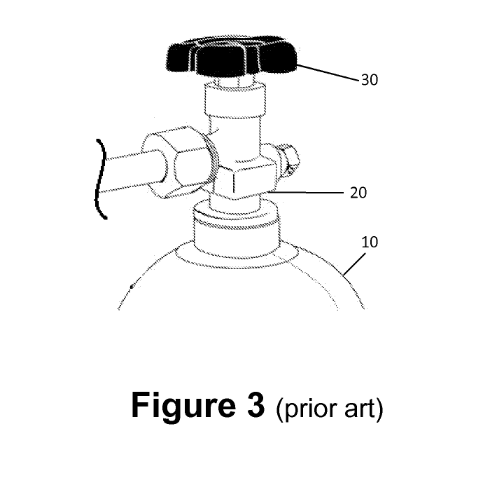

FIG. 3 shows a typical cylindrical tank valve assembly onto which methods and apparatuses of the prior art may be used. A valve assembly 20 is fixed to the top of a cylindrical tank 10. The valve assembly 20 has a rotatable handle 30 which is used to toggle the opening and/or closing of the valve. The apparatus 100 and methods described with respect to FIGS. 1 and 2 may be used on such a valve assembly 20, as well as any other valve assembly.

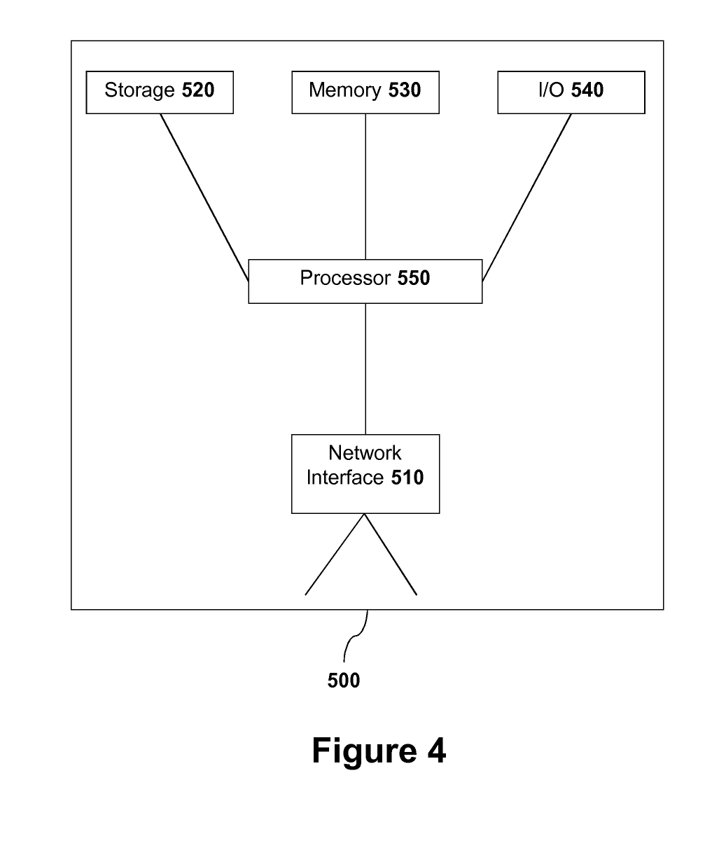

FIG. 4 is a high-level block diagram of a microprocessor device that may be used to carry out the disclosed technology. The device 500 may be employed to control electric motors 140 or other valves of the disclosed technology. The device 500 comprises a processor 550 that controls the overall operation of a computer by executing the reader's program instructions which define such operation. The reader's program instructions may be stored in a storage device 520 (e.g., magnetic disk, database) and loaded into memory 530 when execution of the console's program instructions is desired. Thus, the device 500 will be defined by the program instructions stored in memory 530 and/or storage 520, and the console will be controlled by processor 550 executing the console's program instructions.

The device 500 may also include one or a plurality of input network interfaces for communicating with other devices via a network (e.g., the internet). The device 500 further includes an electrical input interface for receiving power and data. The device 500 also includes one or more output network interfaces 510 for communicating with other devices. The device 500 may also include input/output 540 representing devices which allow for user interaction with a computer (e.g., display, keyboard, mouse, speakers, buttons, etc.).

One skilled in the art will recognize that an implementation of an actual device will contain other components as well, and that FIG. 3 is a high level representation of some of the components of such a device for illustrative purposes. It should also be understood by one skilled in the art that the method and devices depicted in FIGS. 1 through 3 may be implemented on a device such as is shown in FIG. 4.

While the disclosed invention has been taught with specific reference to the above embodiments, a person having ordinary skill in the art will recognize that changes can be made in form and detail without departing from the spirit and the scope of the invention. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the invention.

What is claimed:

1. An apparatus for controlling accidental discharge of pressurized gases from entry point of a pressurized tubular member containing the pressured gases, the apparatus comprising:
a tubular member for holding the pressurized gases in an at least a partial gas phase;
a tubular port body threaded to an upper part of the tubular member in a sealed position;
a dual channel valve top assembly disposed within the tubular port body, wherein a first port is utilized to fill the tubular member with a pressurized gas, and a second port in gas communication with an entry point of the tubular member to discharge the pressurized gas; and
a discharge route defined in part by the second port body and the entry point, and further including a restricted discharge route and a flow channel disposed upward of the second port body, but wherein the discharge route excludes a restrictive element selected from a group of pressure directors, control valves and controlled flow opening; and the restricted discharge route limits flowing rate of the gas discharged from the tubular member when the entry point of the tubular member is exposed to a condition where an unexpected incident occurs.

2. The apparatus of claim 1, wherein the upper part of the tubular member is driven by an electric motor.

3. The apparatus of claim 2, wherein the tubular port body is connected to the entry point through a spring.

4. The apparatus of claim 2, wherein the dual channel valve top assembly is movably connected to a shaft of the electric motor.

5. The apparatus of claim 4, wherein the shaft of the electric motor is connected to the entry point through a second spring.

6. The apparatus of claim 5, wherein a protective cover is included to protect the electric motor.

7. The apparatus of claim 6, wherein the protective cover is adapted to rotatably coupled to the electric motor.

8. The apparatus of claim 7, wherein a side of the protective cover includes an adapter for receiving electricity.

9. The apparatus of claim 8, wherein the protective cover includes an insulating member.

10. The apparatus of claim 9, wherein the apparatus further includes an indicator when the apparatus is operating.

11. The apparatus of claim 10, further comprising a metal filter upstream of the restrictor discharge route.

12. The apparatus of claim 10, wherein the flow channel is disposed downstream of the restrictor discharge route and in communication with the second port.

13. An apparatus for controlling accidental discharge of pressurized gases from the entry point of a pressurized tubular member containing the pressured gases, the apparatus comprising:
a tubular member for holding a pressurized gas in an at least partial gas phase,
a tubular port body threaded to an upper part of the tubular member in a sealed position;
a dual channel port value top assembly disposed within the tubular port body, wherein a first port is utilized to fill the tubular with a pressurized gas, and a second port in gas communication with an entry point of the tubular member to discharge the pressurized gas; and
a discharge route defined in part by the second port body and the entry point, and further including an excess discharge route, and a flow channel disposed upward of the second port body, but wherein the gas flow discharge route excludes a restrictive element selected from a group of pressure directors, control valves and controlled flow openings; and the excess discharge route isolates flow from the tubular member in the event that an incident arises due to pre-set flow rate is exceeded than a threshold value.
